(19) United States
(12) Patent Application Publication
(10) Pub. No.: US 2026/0104242 A1
(43) Pub. Date: Apr. 16, 2026

(54) DEVICE FOR MONITORING WEAVING BY MEANS OF DEFORMATION SENSORS

(71) Applicant: SAFRAN, Paris (FR)

(72) Inventors: Pietro DEL SORBO, MOISSY-CRAMAYEL (FR); Bastien TRANQUART, MOISSY-CRAMAYEL (FR); Salah Eddine MERMOULI, MOISSY-CRAMAYEL (FR)

(73) Assignee: SAFRAN, Paris (FR)

(21) Appl. No.: 19/116,908

(22) PCT Filed: Sep. 28, 2023
(86) PCT No.: PCT/FR2023/051491

§ 371 Date: Mar. 28, 2025

(30) Foreign Application Priority Data
Sep. 30, 2022 (FR) FR2209967

(51) Int. Cl. G01B 7/16; D03J 1/00

(52) U.S. Cl. CPC G01B 7/16; D03J 1/00

(57) ABSTRACT

The invention relates to a system comprising: a harness for a weaving loom and a device for monitoring the manufacture of a preform woven by the loom, the monitoring device comprising: a plurality of sensors, each sensor of the plurality of sensors being connected to one of the plurality of strings and being configured to measure a deformation of the string, the deformation being induced by a force exerted by the loom on the string to which the sensor is connected; and a processing unit connected to the plurality of sensors and configured to analyse the deformation so as to identify a manufacturing abnormality on at least one string.

### TECHNICAL FIELD

The invention concerns the control of the manufacture of a woven preform by a loom and more specifically a data monitoring device for looms for the purpose of weaving management.

### STATE OF THE ART

A Jacquard loom can be used to manufacture three-dimensional (3D) preforms by multi-layer weaving between a plurality of layers of warp yarns and a plurality of layers of weft yarns. A Jacquard loom can also be equipped with a digital control, allowing in particular the automated weaving of the preforms with thicknesses variations, width variations and unbindings. These fibrous preforms can then be injected with a thermosetting resin in order to manufacture, among other things, turbojet engine parts such as fan blades, a retention casing, and/or straighteners.

It is important that the weaving has good quality. And the ability to quickly or even preemptively identify manufacturing defects using an automated algorithm allows for significant gain in terms of production costs.

In this regard, various automated control systems have been developed.

A first family of control systems called “on line” control systems is based on algorithms that process the data called “hot” data, which have been acquired during the manufacture of the preform. They work in parallel with the loom and allow preventive shutdown of the weaving in the event of problems during the process, or in the event of a failure.

A second family of control systems called “off line” control systems is based on algorithms that process the data called “cold” data, which are extracted from the loom once the weaving is complete. This type of approach makes it possible, for example, to avoid subsequent transformations of a preform or even of a part after resin injection, that would be non-compliant, or to support and accelerate the controls carried out by operators during the subsequent manufacture and control of the preform and/or of the part, for example by sending indications and their location or their nature back to tracking sheets.

Some control systems allow an off line control with a function called “follow-up” function. Such control systems detect, for each loom motor, and for each weft insertion, a single motor torque intensity value. However, this value only represents the maximum torque value deployed during a weft insertion for the specified motor, and this on a discrete scale. This function, however, has several drawbacks: it is dependent on the technology of the motor to which it is linked, it provides only a single value per insertion cycle and it has poor discretization.

In any case, the data associated with the operation of the loom present a key role in identifying anomalies within the parts manufactured using the loom. But the algorithms developed for this purpose cannot always detect anomalies, in particular when they do not have access to the right measurements, which adds the need to equip the weaving machines with sensor systems capable of providing measurements, correlated with potential failures.

### DISCLOSURE OF THE INVENTION

One aim of the invention is to improve the monitoring of the manufacture of a woven preform by a loom.

To this end, the invention proposes a system comprising a harness for a loom comprising a plurality of heddles, the harness comprising a collector, a tying board, and a plurality of cords guided by the tying board and the collector, each of the cords of the plurality of cords being designed to be connected to one of the plurality of heddles of the loom; and a device for monitoring the manufacture of a woven preform by the loom, the monitoring device comprising: a plurality of sensors, each sensor of the plurality of sensors being connected to a cord of the plurality of cords and being configured to measure a deformation of the chord, the deformation being induced by a force applied by the loom to the cord to which the sensor is connected; and a processing unit connected to the plurality of sensors and configured to analyze the deformation so as to identify a manufacturing anomaly on at least one chord.

The invention is advantageously completed by the following characteristics taken alone or in any technically possible combination thereof:
the processing unit is configured to analyze the deformation in real time, continuously or with controlled sampling;
the processing unit is configured to analyze the deformation throughout the manufacture of the woven preform;
each sensor of the plurality of sensors comprises a strain gauge, preferably the sensor is a piezoelectric type sensor;
each sensor of the plurality of sensors comprises two ends, each of the two ends being fixed to the cord by means of an adhesion element so that the sensor extends along the chord, the adhesion element preferably comprising resin;
each sensor of the plurality of sensors is fixed to the cord so as to make a junction between two sections of the cord;
each sensor of the plurality of sensors is positioned on the cord so as to extend between the tying board and the collector;
each sensor of the plurality of sensors comprises at least a portion of the chord, the at least one cord portion being configured to measure the deformation of the cord induced by a force applied to the cord by the loom; the processing unit is configured to transmit to the loom instructions resulting from an analysis of the deformation.

Thus, the invention allows for continuous measurements and processes multiple values per insertion cycle. In addition, its signal discretization scale can be chosen on demand because it depends only on the acquisition unit, which is independent of the loom.

Furthermore, this analysis system is compatible with the different types of electronic or mechanical harnesses, and can be adapted to each loom.

The system according to the invention also makes it possible to obtain information on the weaving in real time.

The ability to fix one sensor per cord of the loom harness allows accurately and optimally identifying the type of problem as well as its impact on the manufactured preform.

### PRESENTATION OF THE FIGURES

Other characteristics, aims, and advantages of the invention will emerge from the following description, which is purely illustrative and non-limiting, and which should be read in relation to the appended drawings, in which:
FIG. 1 illustrates a schematic view of a Jacquard-type loom;
FIG. 2 illustrates a schematic view of a harness according to one embodiment;
FIG. 3A and FIG. 3B illustrate different states of a sensor on a cord according to one embodiment;
FIG. 4 illustrates a cord of the harness according to one embodiment;
FIG. 5 illustrates the steps of the monitoring method according to one embodiment.

Throughout the figures, the similar elements bear identical references.

### DETAILED DESCRIPTION

FIG. 1 schematically illustrates a Jacquard-type loom 1 used for making three-dimensional (3D) preforms obtained by multi-layer weaving between a plurality of layers of warp yarns and a plurality of layers of weft yarns.

The loom 1 is equipped with a Jacquard mechanism comprising a plurality of control hooks. The control hooks of the Jacquard mechanism are actuated in translation during the weaving. The Jacquard mechanism is supported by a superstructure 11 called Jacquard head. The loom 1 also comprises a harness 2 and a plurality of heddles 24. The harness 2 comprises a plurality of cords 23. Each cord 23 of the plurality of cords 23 has at least two ends, each cord 23 being connected by one of the two ends to one of the control hooks of the Jacquard mechanism and by the other of the ends to at least one of the heddles 24. The harness 2 also comprises a tying board 22 and a collector 21 adapted to guide the cords 23 of the harness 2. The loom 1 further comprises a monitoring device 3 comprising at least one sensor 30, a processing unit 31 and at least one connection wire 32 for connecting the sensor(s) 30 to the processing unit 31. According to one embodiment presented below, the monitoring device 3 comprises a plurality of sensors 30, so that each sensor 30 is connected to each cord 23, and that advantageously each cord 23 is connected to exactly one sensor 30.

Each heddle 24 comprises an eyelet 25 through which a warp yarn 40 passes. The heddles 24 and their associated eyelets 25 are driven by a substantially vertical oscillating movement. The displacement of each heddle 24 depends on several forces: the spring 26 return force, the return force of actuators of the Jacquard head 11, the return force of the warp yarns 40 and any friction due to the interactions at the level of the eyelets 25. The heddles 24 allow lifting some warp yarns 40 and thus creating a shed allowing the introduction of weft yarns 41. More specifically, each heddle 24 is actuated and driven individually, which allows raising or lowering each warp yarn 40 independently. It thus becomes possible to achieve the spacing of the warp yarns 40 necessary for the passage of a rapier that carries the weft yarn 41 and to weave complex patterns and to pass the warp yarns 40 from one layer to another, allowing the creation of a three-dimensional fibrous architecture. After each passage of the weft yarn 41, a beating comb 50 compacts the fabric leaving the loom 1, which allows obtaining the desired weaving.

The heddles 24 are spatially distributed according to the position of the holes 221 of the tying board 22, that is to say according to a plurality of columns and rows. The density of the holes 221 in the tying board 22 corresponds to the density of the fabric to be made, that is to say there is in the tying board 22 a spacing between each column of holes equivalent to the one present between each warp column in the fabric to be made. The loom 1 further comprises a creel for supporting several bobbins of warp yarns. Each bobbin is movable in rotation about an axis so as to be able to unwind its warp yarn. Each warp yarn can pass through guide eyelets 25 then through a hole in a tying board similar to the tying board 22, and finally passes through the eyelet 25 of a heddle 24.

FIG. 2 illustrates the harness 2 of a loom 1 according to one embodiment. As explained previously, the harness 2 comprises several cords 23. The cords 23 of the harness 2 are each attached by a first of their ends to a control hook of the Jacquard mechanism. These cords 23 are therefore independently subjected to a force applied by the control hook to which they are linked. The cords 23 are each attached, by a second of their ends, to a heddle 24. Between this first and this second end, each cord 23 is guided by a collector 21 and a tying board 22. The collector 21 of the harness 2 is positioned on the side of the first end, in the vicinity of the Jacquard mechanism, and the tying board 22 on the side of the second end and therefore in the vicinity of the heddles 24. Thus, each cord 23 extends from the Jacquard mechanism to a heddle 24 via the collector 21 and then through a hole 221 in the tying board 22.

Such a harness can be linked to a monitoring device 3 for analyzing the deformations undergone by the cords 23. The monitoring device 3 comprises a plurality of sensors 30, a processing unit 31 and a plurality of connection wires 32. Preferably, each sensor 30 is connected to the processing unit 31, via a connection wire 32. Advantageously, each connection wire 32 comprises an input cable and an output cable, each connecting one end of the sensor 30 to the processing unit 31.

According to one preferred embodiment, each sensor 30 is connected to each cord 23. Advantageously, each cord 23 is connected to exactly one sensor 30. Thus, the monitoring device 3 can monitor the evolutions in the tension of the cords 23 and therefore notice changes identified as weaving defects or anomalies. During the weaving, errors may occur. For example, it is possible for a cord 23 to get stuck or come into contact with another or to break. It also happens that one of the cords 23 is not in a good position, which can generate over-tensions or under-tensions. Such disturbances are detrimental to the quality of the woven preform.

The processing unit 31 analyzes the deformation(s) related to the application of forces to the cords 23 thanks to the data measured by the sensors 30 positioned on the cords 23 and transmitted to it via the connection wires 32.

The monitoring device 3 is independent of the loom 1, it can therefore adapt to each loom 1. It is able to detect any tension anomaly on each cord 23 comprising a sensor 30. Furthermore, the discretization scale of the analyzed signal depends only on the monitoring device 3 and can therefore be chosen independently of the loom 1. Thus, the sampling is modifiable and can be controlled independently of the loom 1.

Each sensor 30 is positioned on each cord 23 of the harness 2 and advantageously between the collector 21 and the tying board 22 so as to avoid the problems of friction between the sensors 30, the spacings between the cords 23 being greater at this level and so as to ensure that the presence of the connection wires 32 is restricted to this area. The position of the sensor 30 between the tying board 22 and the collector 21 prevents the connection wires 32 from the sensors 30 to the processing unit 31 from disturbing the weaving. It facilitates the installation of the sensors 30 and prevents the cords 23 from getting stuck due to the presence of the sensors 30.

The working environment is therefore not disturbed by the presence of the sensors 30 and of the corresponding connection wires 32.

According to one embodiment, the sensors 30 are positioned so as not to come into contact with the collector 21 and/or the tying board 22 during the displacements of the cord 23 between a high position and a low position. The high position is obtained under the effect of traction applied by the hook linked to the cord 23 and the low position is obtained once released under the effect of the spring return force 26. One mode of operation of the sensor 30 is explained in detail below.

The sensors 30 are preferably strain gauges, advantageously of the piezoelectric type, but they can be of any other type. The ends of each sensor 30 are fixed to one of the cords 23 so as to elongate according to the deformation of the cord 23 while allowing its free deformation. Advantageously, the sensors 30 are fixed to the cords 23 by means of a resin or another adhesive material.

According to one embodiment, the ends of each sensor 30 are fixed to a cord 23 so as to be along a portion of the cord 23. This configuration could be called “parallel fixing”, and according to another embodiment, the ends of each sensor 30 are fixed to a cord 23 so as to make the junction between two sections of the cord 23; this other configuration could be called “serial fixing”.

FIGS. 3A and 3B illustrate states of a sensor 30 during the application of a force F to the cord 23 to which it is fixed. The ends of the sensor 30 being linked to the cord 23 as explained above, the sensor 30 undergoes the same displacement as the cord 23 during the application of the force F on this cord 30. The sensor 30 then measures the force F applied to the cord 23 by measuring the deformation induced by the displacement of the cord 23. Indeed, the deformation is a function of the tension applied to the cord 23 by the force F. If no force is applied to the cord 23 (FIG. 3A), the sensor 30 does not measure any deformation and therefore measures a zero relative force; whereas if a force F is applied (FIG. 3B), the sensor 30 measures a deformation of the cord 23 and measures the force F.

According to one embodiment, illustrated in FIG. 4, each sensor 30 comprises at least a portion of each cord 23. This cord portion 23 is configured to measure the deformation of the cord 23 induced by a force F applied on the cord 23 by the loom 1. Preferably, the sensor 30 comprises the entire length of the cord 23, in this way the cord 23 is considered as piezoresistive. The cord 23 then has, in addition to its function of transmitting the forces from the Jacquard loom to the heddles 24, a measurement function. In this embodiment, the cord 23 takes the role and function of the sensor 30. This embodiment makes it possible to limit the bulk of the loom 1 and improves the integration of the monitoring device 3 in the loom 1. In addition, the accuracy of the measurements is improved.

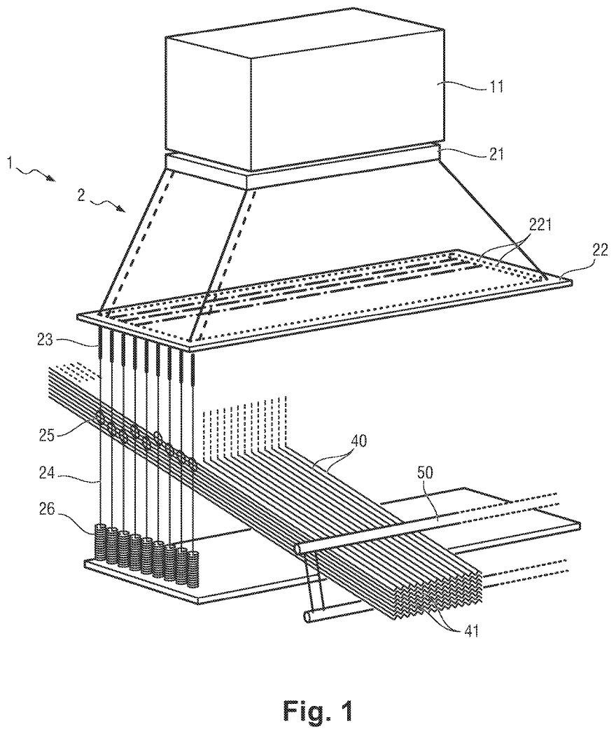

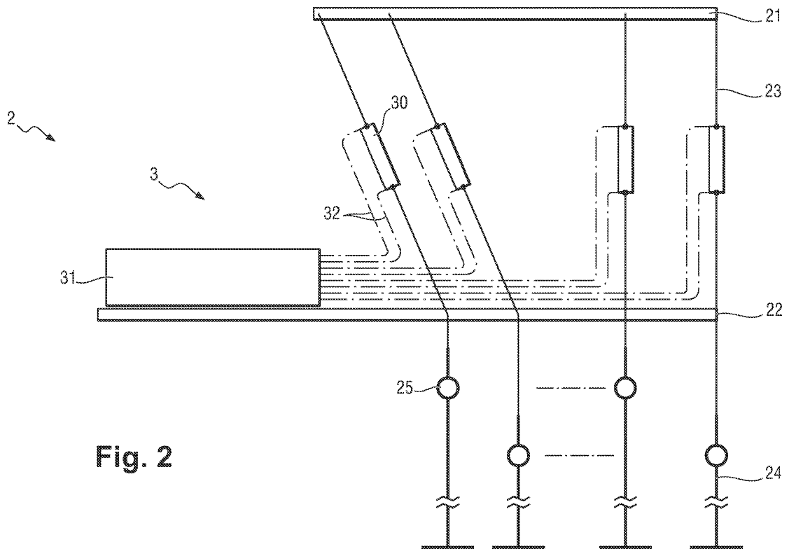

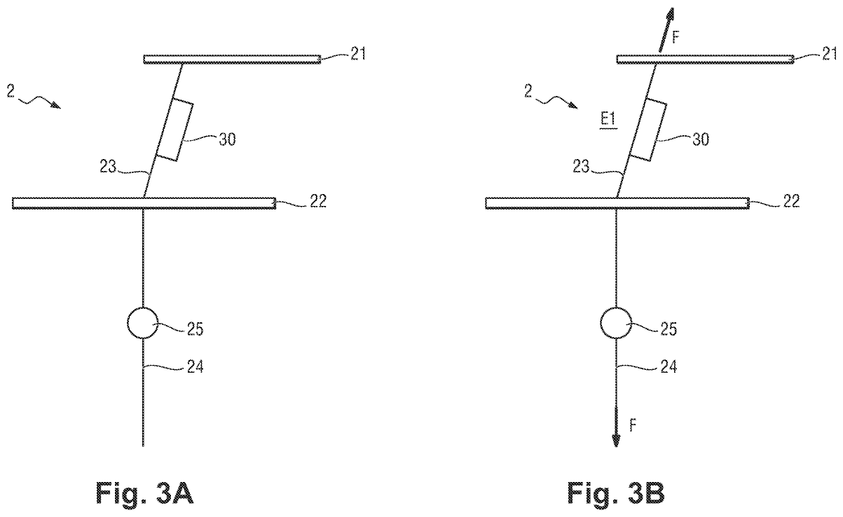

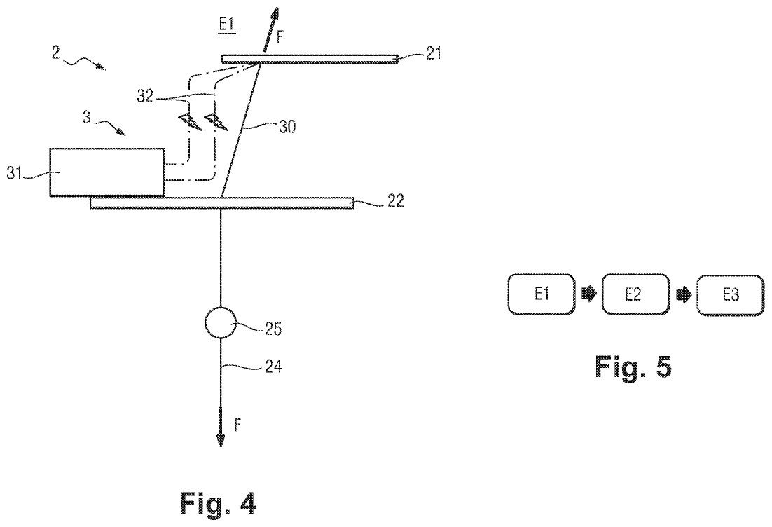

FIG. 5 illustrates the general steps of a method for monitoring the manufacture of a woven preform by a loom according to one mode of implementation. The monitoring of the manufacture of a woven preform implements a loom 1. The loom 1 is preferably as described previously and illustrated by FIG. 1, but it can also be any other loom. The loom 1 used comprises a harness 2 as described previously and illustrated by FIG. 2. The harness 2 comprises a plurality of cords 23 for connecting the Jacquard mechanism to the heddles 24 lifting the warp yarns 40. The cords 30 transmit the movements of the hooks of the Jacquard mechanism to the warp yarns 40 and thus allow performing the weaving.

Such a loom 1 comprising at least one sensor 30 on each of its cords 23 is then driven by the Jacquard mechanism. Each hook is controlled to apply a force F on the cord 23 to which it is linked, according to the weaving program. During a step of applying the force F to one (or more) cords 23, the inner tension of the latter increases, and the force F is transmitted to the heddle 24 linked to the cord 23. The sensor 30, linked to the cord 23 on which the force F is applied, then measures E1 the force applied to the cord 23 by measuring the deformation induced by the displacement of the cord 23. As explained previously, the ends of each sensor 30 being connected to one of the cords 23, the modification of the tension of a cord 23, due to the application of a force, is measured by the sensor 30. It is possible that the Jacquard mechanism actuates several control hooks simultaneously, several cords 23 are then subjected to a force F and the sensors 30 fixed to these cords 23 then measure E1 the forces applied to the plurality of cords 23.

This measurement is then transmitted via the connection wires 32 connecting each sensor 30 to the processing unit 31. The processing unit 31 analyzes E2 the data received by the plurality of sensors 30 in order to identify manufacturing anomalies on at least one or more of the cords 23.

According to one embodiment, the processing unit 31 is adapted to transmit E3 to the loom 1 instructions resulting from the analysis E2 of the deformations of each cord 23 to which a sensor 30 is connected. This makes it possible to improve the weaving method and possibly to avoid greater degradation of the loom and/or of the woven preform.

1. A system comprising:
a harness for a loom comprising a plurality of heddles wherein the harness comprises a collector a tying board and a plurality of cords guided by the tying board and the collector, each of the cords being designed to be connected to one of the plurality of heddles of the loom; and
a device for monitoring the manufacture of a woven preform by the loom; and wherein the monitoring device comprises:
sensors, each of the sensors being connected to one of the cords and being configured to measure a deformation of the cord, the deformation being induced by a force applied by the loom to the cord to which the sensor is connected; and
a processing unit connected to the sensors and configured to analyze the deformation to identify a manufacturing anomaly on at least one of the cords.

2. The system according to claim 1, wherein the processing unit is configured to analyze the deformation in real time, continuously or with controlled sampling.

3. The system according to claim 1, wherein the processing unit is configured to analyze the deformation throughout the manufacture of the woven preform.

4. The system according to claim 1, wherein each of the sensors comprises a strain gauge.

5. The system according to claim 1, wherein each of the sensors comprises two ends, each of the two ends being fixed to one of the cord by means of an adhesion element so that the sensor extends along the cord.

6. The system according to claim 1, wherein each of the sensors is fixed to one of the cords so as to make a junction between two sections of the cord.

7. The system according to claim 1, wherein each of the sensors is positioned on one of the cords so as to extend between the tying board and the collector.

8. The system according to claim 1, wherein each of the sensors comprises at least a portion of the one of the cords, the at least one portion being configured to measure the deformation of the cord induced by a force applied to the cord by the loom.

9. The system according to claim 1, wherein the processing unit is configured to transmit to the loom instructions resulting from an analysis of the deformation.
